(19) United States
(12) Patent Application Publication
(10) Pub. No.: US 2026/0085995 A1
(43) Pub. Date: Mar. 26, 2026

(54) EVALUATION METHOD AND APPARATUS FOR JUDGING ELECTROMECHANICAL STATE OF TRANSFORMER USING WIDEBAND VIBRATION FEATURE

(71) Applicant: Zhejiang Huadian Equipment Testing and Research Institute Co. LTD., Zhejiang (CN)

(72) Inventors: ZHIYAO ZHENG, Zhejiang (CN); JIALING LI, Zhejiang (CN); JIANQIN LIN, Zhejiang (CN); JIAMING LIANG, Zhejiang (CN); HANPENG YANG, Zhejiang (CN); YUJIA HU, Zhejiang (CN); ZHI LI, Zhejiang (CN); YUHUI MA, Zhejiang (CN); DINGFANG KE, Zhejiang (CN); SHENG XIANG, Zhejiang (CN); CONGWEI YU, Zhejiang (CN)

(21) Appl. No.: 18/961,946

(22) Filed: Nov. 27, 2024

(30) Foreign Application Priority Data
Sep. 23, 2024 (CN) 2024113216192
Nov. 5, 2024 (CN) 2024115627211

(51) Int. Cl. G01M 7/02

(52) U.S. Cl. CPC G01M 7/025

(57) ABSTRACT

An evaluation method for judging an electromechanical state of a transformer includes receiving a wideband detection signal collected by a sensor, performing filtering processing on the wideband detection signal based on a filter to obtain a wideband vibration signal, and sampling the wideband vibration signal and a power-frequency voltage in real time, to obtain a wideband sample signal and a voltage sample signal, performing Fourier decomposition and reconstruction on the wideband sample signal to obtain low and high frequency diagnostic signals corresponding to the target transformer, processing the low-frequency diagnostic signal based on a mechanical diagnostic policy to obtain a fault signal eigenvalue, and obtaining a mechanical fault result according to the fault signal eigenvalue, and processing the high-frequency diagnostic signal to obtain a phase resolved partial discharge diagram, and obtaining a partial discharge fault result based on the phase resolved partial discharge diagram.

### CROSS-REFERENCE TO RELATED APPLICATION AND CLAIM OF PRIORITY

This application claims the benefit under 35 USC § 119 of China Patent Application Nos. 2024113216192 filed on Sep. 23, 2024 and 2024115627211 filed on Nov. 5, 2024, in the Chinese Intellectual Property Office, the entire disclosure of which are incorporated herein by reference for all purposes.

### BACKGROUND

### 1. Technical Field

The present invention relates to data processing technologies, and in particular, to an evaluation method and apparatus for judging an electromechanical state of a transformer using a wideband vibration feature.

### 2. Background Art

In an electrical power system, a transformer is used as a core device for energy conversion and transfer, and an operation state of the transformer is directly related to the stability and security of the entire system. Therefore, a timely and accurate state evaluation on the transformer is crucial. Common fault types of the transformer include a mechanical fault and an insulation fault of a core and a winding. These faults are often accompanied by changes in an electrical signal and a vibration signal, which provides an important basis for fault diagnosis.

A traditional evaluation method for an electromechanical state of the transformer depends on respective collection of a low-frequency vibration signal and a high-frequency ultrasonic signal, to monitor a mechanical state and an insulation state in the transformer. However, this method has a significant technical bottleneck. First, a low-frequency vibration sensor and a high-frequency ultrasonic sensor cannot perform synchronous measurement at the same position and at the same time, resulting in data asynchronization and increasing the complexity and errors of fault diagnosis. Secondly, the application of a multi-sensor detection system not only occupies a large amount of space, but also makes the entire system redundant and costly. In addition, the method requires a high professional skill of an operator, is complex in a data processing process, and lacks quantitative vibration characteristic signal analysis. Therefore, an evaluation result often depends on the experience of the operator and has great subjectivity and uncertainty.

### SUMMARY

Embodiments of the present invention provide an evaluation method and apparatus for judging an electromechanical state of a transformer using a wideband vibration feature, which may collect and analyze a low-frequency vibration signal and a high-frequency ultrasonic signal that are on a surface of the transformer simultaneously, implementing detection of a wideband vibration signal at the same time and at the same position. Therefore, accuracy of fault diagnosis is not only improved, but also dependence on a professional skill of an operator is reduced.

According to a first aspect of the embodiments of the present invention, a flowchart of an evaluation method for judging an electromechanical state of a transformer using a wideband vibration feature is provided and includes:
receiving a wideband detection signal collected by a sensor for a target transformer, performing filtering processing on the wideband detection signal based on a filter, to obtain a wideband vibration signal, and sampling the wideband vibration signal and a power-frequency voltage in real time, to obtain a wideband sample signal and a voltage sample signal;
performing Fourier decomposition and reconstruction on the wideband sample signal, to obtain a low-frequency diagnostic signal and a high-frequency diagnostic signal that correspond to the target transformer;
processing the low-frequency diagnostic signal based on a mechanical diagnostic policy, to obtain a fault signal eigenvalue, and obtaining a mechanical fault result according to the fault signal eigenvalue; and
processing the high-frequency diagnostic signal according to a partial discharge diagnostic policy, to obtain a phase resolved partial discharge diagram, and obtaining a partial discharge fault result based on the phase resolved partial discharge diagram.

Optionally, in a possible implementation of the first aspect, the processing the low-frequency diagnostic signal based on a mechanical diagnostic policy, to obtain a fault signal eigenvalue, and obtaining a mechanical fault result according to the fault signal eigenvalue includes:
using the low-frequency diagnostic signal as an input signal of the target transformer;
extracting a non-extremum point in the low-frequency diagnostic signal, and calculating, based on the non-extremum point and the input signal, an extremum point signal corresponding to an extremum point in the low-frequency diagnostic signal;
converting the extremum point signal based on a linear conversion manner, to obtain a signal residual amount, and calculating the signal residual amount, to obtain decomposition of an intrinsic mode; and
performing calculation according to the decomposition of the intrinsic mode, to obtain the fault signal eigenvalue, and obtaining the mechanical fault result according to the fault signal eigenvalue.

Optionally, in a possible implementation of the first aspect, the calculating, based on the non-extremum point and the input signal, an extremum point signal corresponding to an extremum point in the low-frequency diagnostic signal includes:
obtaining the extremum point signal through the following formula:

$$R ( t ) = f ( t ) - f ( {t}_{j} )$$

where R(t) is the extremum point signal, f(t) is the input signal of the target transformer, and f(tⱼ) is a signal corresponding to a sampling time of the non-extremum point.

Optionally, in a possible implementation of the first aspect, the converting the extremum point signal based on a linear conversion manner, to obtain a signal residual amount includes:
obtaining the signal residual amount through the following formula:

$$r ( t ) = R ( t ) + [ R ( {t}_{j + 1} ) - R ( {t}_{j} ) ]$$

where r(t) is a residual amount obtained after the extremum point signal is converted, R(tⱼ₊₁) is an extremum point corresponding to a j+1^{th} low-frequency diagnostic signal, and R(tⱼ) is an extremum point corresponding to a j^{th} low-frequency diagnostic signal.

Optionally, in a possible implementation of the first aspect, the calculating the signal residual amount, to obtain decomposition of an intrinsic mode includes: obtaining the decomposition of the intrinsic mode through the following formula:

$$α = r ( t ) \times {P}_{i - 1} \times {P}_{i} \times γ$$

where α is decomposition of an intrinsic mode of a vibration signal, Pᵢ₋₁ is a sinusoidal signal component corresponding to an i−1^{th} sampling point, Pᵢ is a cosine signal component corresponding to an i^{th} sampling point, and γ is a coordinate of a control point.

Optionally, in a possible implementation of the first aspect, the performing calculation according to the decomposition of the intrinsic mode, to obtain the fault signal eigenvalue includes:
obtaining the fault signal eigenvalue through the following formula:

$$K = \frac{A \times α}{{\sum }_{i > 1}^{n} {L}_{i}^{2}}$$

where K is a fault eigenvalue of the vibration signal, A is an amplitude of a frequency point, Lᵢ is a harmonic content in an i^{th} low-frequency diagnostic signal, and n an upper limit value of a quantity of low-frequency diagnostic signals.

Optionally, in a possible implementation of the first aspect, the obtaining the mechanical fault result according to the fault signal eigenvalue includes:
when it is judged that the fault signal eigenvalue is greater than 10, generating a severe mechanical fault result;
when it is determined that the fault signal eigenvalue is less than 5, generating a mild mechanical fault result; and
when it is determined that the fault signal eigenvalue is greater than and equal to 5 and is less than and equal to 10, generating a repeated verification result to be sent to a management end.

Optionally, in a possible implementation of the first aspect, the processing the high-frequency diagnostic signal according to a partial discharge diagnostic policy, to obtain a phase resolved partial discharge diagram includes:
processing the high-frequency diagnostic signal based on a high-frequency envelope detection circuit, to obtain an ultrasonic detection signal;
obtaining a maximum amplitude of an ultrasonic signal according to the ultrasonic detection signal, and determining a voltage phase corresponding to the maximum amplitude as an amplitude phase;
constructing a phase resolved initial discharge diagram, where the phase resolved initial discharge diagram has a discharge coordinate system, a horizontal axis of the discharge coordinate system is the voltage phase, and a vertical axis thereof is an amplitude of the ultrasonic signal; and
counting the maximum amplitude and the amplitude phase based on a preset time period, to obtain a plurality of discharge coordinates, and constructing a discharge coordinate point in the discharge coordinate system based on the discharge coordinates, to obtain the phase resolved partial discharge diagram.

Optionally, in a possible implementation of the first aspect, the obtaining a partial discharge fault result based on the phase resolved partial discharge diagram includes: dividing the phase resolved partial discharge diagram based on a voltage phase angle of 10°, to obtain a plurality of phase intervals;
counting a quantity of discharge coordinate points in each of the phase intervals, to obtain a discharge interval quantity, and counting a quantity of all discharge coordinate points in the phase resolved partial discharge diagram, to obtain a total discharge quantity;
obtaining a discharge ratio according to a ratio of the discharge interval quantity to the total discharge quantity, and counting a quantity of discharge intervals with the discharge ratio greater than and equal to 4%, to obtain an interval accumulation quantity; and obtaining an accumulative judgment interval based on a product of the interval accumulation quantity and 10°, and when it is determined that the accumulative judgment interval is greater than 120°, generating a floating potential discharge fault result.

Optionally, in a possible implementation of the first aspect, the obtaining a partial discharge fault result based on the phase resolved partial discharge diagram includes: invoking a preset gap voltage, and determining a plurality of voltage judgment intervals at a horizontal axis in the phase resolved partial discharge diagram based on the preset gap voltage and a preset quantity;
selecting a minimum voltage judgment interval as a floating judgment interval, and using the rest of voltage judgment intervals as change rate judgment intervals;
when it is determined that an amplitude of a discharge coordinate point in the phase resolved partial discharge diagram is in the floating judgment interval, generating a floating potential discharge fault result;
calculating a change rate of a corresponding quantity of discharge coordinate points in the change rate judgment interval;
when it is determined that the change rate is greater than 2, generating a point discharge fault result; and
when it is judged that the change rate is less than and equal to 2, generating a surface discharge fault result.

According to a second aspect of the embodiments of the present invention, an evaluation apparatus for an electromechanical state of a transformer is applicable to an evaluation method for an electromechanical state of a transformer, configured to detect a transformer fault, and adapted to a multi-frequency sensor mounted on a transformer side, which includes: a signal collection module, a signal processing module, and a signal diagnostic module, where
the signal collection module is electrically connected to the signal processing module and is configured to collect a wideband signal of the multi-frequency sensor mounted on the transformer side;
the signal processing module is electrically connected to the signal diagnostic module and is configured to perform time-frequency calibration on a collected wideband signal and adaptively adjust a frequency range and a storage time according to a signal feature of the wideband signal, to obtain a low-frequency diagnostic signal and a high-frequency diagnostic signal; and
the signal diagnostic module is electrically connected to a decision module and is configured to recognize a fault pattern on a corresponding band according to multi-dimension features of the low-frequency diagnostic signal and the high-frequency diagnostic signal.

In the solution, the signal collection module is connected to the multi-frequency sensor mounted on the transformer side and is responsible for catching the wideband signal during an operation of the transformer in real time and with high precision. The wideband signal covers a wide range from a low frequency to a high frequency, which can comprehensively reflect an operation state of the transformer, including changes in various physical quantities such as vibration and sound. The signal processing module receives original data from the signal collection module and further performs complicated time-frequency calibration processing, to ensure signal accuracy and reliability. At the same time, the signal processing module can dynamically adjust a frequency monitoring range and a data storage policy according to a feature of a received wideband signal and effectively respond to signal changes of the transformer under different working conditions, to improve sensitivity and accuracy of fault detection. The signal diagnostic module performs deep analysis on a processed signal and extracts the multi-dimension features such as a frequency, an amplitude, a phase, and an energy distribution, to recognize the fault pattern on the corresponding band. Accuracy and an early warning capability of fault detection can be significantly improved through multi-dimension analysis. According to the present application, dynamic feature analysis and an adaptive learning technology are combined to provide strong technical support for secure and efficient operations of the transformer.

Optionally, in a possible implementation of the second aspect, the signal collection module includes a low-frequency signal collection unit responding to a mechanical vibration signal and a high-frequency signal collection unit responding to an ultrasonic signal.

Optionally, in a possible implementation of the second aspect, the signal processing module includes a time-frequency calibration unit, a frequency adjustment unit, and a time sequence storage unit;
the time-frequency calibration unit adjusts sampling times of the low-frequency signal collection unit and the high-frequency signal collection unit according to a time domain adjustment factor and a frequency domain adjustment factor to obtain a time-frequency domain synchronization signal;
the frequency adjustment unit adaptively adjusts a corresponding frequency signal in response to the time-frequency domain synchronization signal to obtain a target state signal;
the time sequence storage unit stores the target state signal to a corresponding storage position according to a synchronization mark of the time-frequency domain synchronization signal; and
the target state signal includes the low-frequency diagnostic signal and the high-frequency diagnostic signal.

Optionally, in a possible implementation of the second aspect, the frequency adjustment unit includes a high-frequency adjustment unit and a low-frequency adjustment unit; the high-frequency adjustment unit responds to an ultrasonic signal in the time-frequency domain synchronization signal; and the low-frequency adjustment unit responds to a mechanical vibration signal in the time-frequency domain synchronization signal.

Optionally, in a possible implementation of the second aspect, the frequency adjustment unit further includes a signal amplification unit, and the signal amplification unit is constructed using a T-type resistance feedback network charge amplification circuit.

Optionally, in a possible implementation of the second aspect, the frequency adjustment unit further includes an envelope detection unit that performs upper envelope detection on the ultrasonic signal.

Optionally, in a possible implementation of the second aspect, the signal diagnostic module includes a frequency domain feature extraction unit, a time domain feature extraction unit, a time-frequency domain feature extraction unit, and an envelope analysis unit; and the signal diagnostic module determines a corresponding unit combination pattern in response to frequency ranges of the low-frequency diagnostic signal and the high-frequency diagnostic signal to generate a corresponding fault pattern.

Optionally, in a possible implementation of the second aspect, that the signal diagnostic module determines a corresponding unit combination pattern in response to frequency ranges of the low-frequency diagnostic signal and the high-frequency diagnostic signal to generate a corresponding fault pattern includes the following steps: extracting the low-frequency diagnostic signal in the target state signal, and determining, by the time domain feature extraction unit, a first low-frequency fault pattern according to a mean value, a variance, a peak value, and kurtosis in the low-frequency diagnostic signal;
analyzing, by the frequency domain feature extraction unit, spectrum energy, a center frequency, a bandwidth, and a harmonic component in the low-frequency diagnostic signal according to Fourier transform to determine a second low-frequency fault pattern; and
determining a target low-frequency fault pattern according to the first low-frequency fault pattern and the second low-frequency fault pattern.

Optionally, in a possible implementation of the second aspect, that the signal diagnostic module determines a corresponding unit combination pattern in response to frequency ranges of the low-frequency diagnostic signal and the high-frequency diagnostic signal to generate a corresponding fault pattern further includes the following steps:
extracting the high-frequency diagnostic signal in the target state signal, and extracting, by the envelope analysis unit, an envelope feature of the high-frequency diagnostic signal through Hilbert transform and demodulation analysis to obtain modulation information and transient impact information to determine a first high-frequency fault pattern;
performing, by the frequency domain feature extraction unit, spectrum analysis on the high-frequency diagnostic signal, and extracting a high-frequency component and a harmonic wave to recognize a high-frequency vibration source to determine a second high-frequency fault pattern;
obtaining, by the time-frequency domain feature extraction unit, a pulse amplitude and a voltage phase of the high-frequency diagnostic signal on a set time scale to obtain a third high-frequency fault pattern; and
determining a target high-frequency fault pattern according to the first high-frequency fault pattern, the second high-frequency fault pattern, and the third high-frequency fault pattern.

Optionally, in a possible implementation of the second aspect, a decision module, responding to a fault pattern and displaying a fault through a visual tool, is further included, where
the decision module includes a display unit and an alarm unit, and the display unit displays a target low-frequency fault pattern or/and a target high-frequency fault pattern through a vibration frequency domain diagram or/and a partial discharge PRPD diagram; and
the alarm unit sends a fault pattern of a target transformer to a remote platform or/and a mobile terminal.

According to a third aspect of the embodiments of the present invention, an electronic device is provided and includes: a memory, a processor, and a computer program, where the computer program is stored in the memory, and the processor runs the computer program to execute the method according to the first aspect and the possible implementations in the first aspect of the present invention.

Beneficial effects of the present invention are as follows:
1. The evaluation method for judging an electromechanical state of a transformer using a wideband vibration feature provided in the present invention significantly improves detection synchronism and accuracy of the state of the transformer. In a traditional method, different sensors need to be used to measure the low-frequency vibration signal and the high-frequency ultrasonic signal respectively, and synchronous measurement cannot be implemented at the same time and at the same position, resulting in an error in a detection result. According to the present invention, a contact-type acoustic transmission complex sensor is used, so that the low-frequency vibration signal and the high-frequency ultrasonic signal that are on the surface of the transformer can be collected simultaneously, thereby implementing real-time synchronous measurement of the wideband vibration signal. This improvement not only simplify a detection process, but also reduces the error brought by asynchronous detection, thereby improving precision and reliability of fault recognition.
2. According to the present invention, innovation is implemented in signal processing and analysis aspects, thereby implementing quantitative evaluation for the wideband vibration signal. Filtering and Fourier decomposition and reconstruction are performed on the collected wideband vibration signal, to decompose the signal into the low-frequency vibration signal and the high-frequency ultrasonic signal, and a vibration signal analysis technology and a high-frequency envelope detection circuit are respectively introduced for processing. In this process, an eigenmode decomposition technology is applied to enable an eigenvalue of the vibration signal to be accurately extracted, and a fault eigenvalue K is obtained through quantitative calculation, thereby objectively evaluating a mechanical fault severe degree of the transformer. Meanwhile, in combination with a PRPD diagram drawn through an envelope curve of the ultrasonic signal and a voltage phase signal, diagnosis accuracy of a partial discharge fault is further improved. According to this series of signal processing and analysis methods, a subjective evaluation pattern that depends on the experience and judgment of the operator in the past is abandoned, so that the evaluation result is more scientific and objective.
3. The implementation of the present invention not only improves evaluation efficiency and accuracy of the state of the transformer, but also reduces detection costs and operation difficulty. A traditional multi-sensor detection manner requires a professional device and a complicated data processing system, which is large in operation difficulty and high in costs. However, a single-sensor detection manner used in the present invention simplifies a detection system, reduces device occupation space, and reduces the detection costs. Meanwhile, since the real-time synchronous measurement and the quantitative evaluation of the wideband vibration signal are implemented, the operator may perform accurate fault diagnosis without high professional skill and experience. This improvement not only improves detection convenience and universality, but also helps improve an overall operation and maintenance level of an electrical power system and ensure a secure and stable operation of the electrical power system.
4. For a problem of an unreliable detection result caused by asynchronous signal analysis of the state of the transformer, according to the present application, further, the wideband signal of the transformer is caught in real time through the signal collection module, and the time-frequency calibration unit in the signal processing module is used to perform precise time domain and frequency domain adjustments on the low-frequency signal and the high-frequency signal, to ensure the synchronism of the low-frequency signal and the high-frequency signal in time and frequency domains. This not only improves signal accuracy, but also ensures reliability of subsequent fault analysis, thereby effectively solving the problem of the unreliable detection result caused by the asynchronous signal.
5. For a problem of incomprehensive and inaccurate fault detection of the transformer, the present application further provides the evaluation apparatus for an electromechanical state of the transformer, which not only collects the wideband signal of the transformer, but also performs deep multi-dimension feature analysis on these signals through the signal diagnostic module. The multi-dimension feature includes a time domain feature, a frequency domain feature, a time-frequency domain feature, an envelope feature, and the like, which can comprehensively reflect an operation state of the transformer and comprehensively and accurately detect the fault of the transformer.
6. For a problem of a slow response speed of the fault detection of the transformer, according to the present invention, functions such as signal collection, processing, diagnosis, and decision are integrated in one apparatus, thereby implementing an efficient signal processing and fault diagnosis process. Particularly, the decision module is designed to rapidly respond to the fault pattern, display fault information through a visual tool, and send a fault alarm to a remote platform or a mobile terminal at the same time. The integrated design and rapid response mechanism significantly improve efficiency and timeliness of the fault detection of the transformer and help take a maintenance measure in time, to ensure a secure operation of the transformer.

### BRIEF DESCRIPTION OF THE DRAWINGS

FIG. 1 is a flowchart of an evaluation method for judging an electromechanical state of a transformer using a wideband vibration feature according to the present invention;

FIG. 2 is a schematic diagram of detection of a transformer according to the present invention;

FIG. 3 is a schematic structural diagram of an evaluation apparatus for an electromechanical state of a transformer according to the present invention;

FIG. 4 is a schematic diagram of a detection circuit of an evaluation apparatus for an electromechanical state of a transformer according to the present invention;

FIG. 5 is a detection effect diagram of an evaluation apparatus for an electromechanical state of a transformer according to the present invention;

FIG. 6 is a vibration frequency domain diagram according to the present invention;

FIG. 7 is a PRPD diagram under a partial discharge fault according to the present invention; and

FIG. 8 is a schematic structural diagram of hardware of an electronic device according to the present invention.

### DETAILED DESCRIPTION OF THE EMBODIMENTS

To make the objectives, technical solutions, and advantages of the embodiments of the present invention clearer, the following clearly and completely describes the technical solutions in the embodiments of the present invention with reference to the accompanying drawing in the embodiments of the present invention. Apparently, the described embodiments are only some but not all of the embodiments of the present invention. Based on the embodiments in the present invention, all other embodiments obtained by those of ordinary skill in the art without making creative efforts shall fall within the protection scope of the present invention.

The terms “first”, “second”, “third”, “fourth”, and the like (if any) in the specification and claims of the present invention and in the above accompanying drawing are intended to distinguish between similar objects but do not necessarily indicate a specific order or sequence. It should be understood that the data used in this way can be interchanged where appropriate so that the embodiments of the present invention described herein may be implemented in an order other than those illustrated or described herein.

It should be understood that the serial number of each step of various embodiments of the present invention does not indicate the execution sequence, which should be determined by the function and internal logic of the step, and shall not limit the implementation of the embodiments of the present invention.

It should be understood that, in the present invention, the terms “include” and “comprise” as well as any variations thereof are intended to cover non-exclusive inclusions, for example, processes, methods, systems, products, or devices that contain a series of steps or units are not necessarily limited to the steps or units explicitly listed, and may instead include other steps or units not explicitly listed or inherent to these processes, methods, products, or equipment.

It should be understood that, in the present invention, “a plurality of” refers to two or more. The term “and/or” is merely an association relationship describing associated objects, indicating that there may be three relations, for example, A and/or B may indicate the following three cases: A exists individually, A and B exist simultaneously, and B exists individually. The character “/” generally indicates that the associated objects before and after the character form an “or” relation. “Including A, B, and C” and “including A, B, C” mean that all three of A, B, and C are included, “including A, B, or C” means that one of A, B, and C is included, and “including A, B and/or C” means any one, two, or three of A, B, and C are included.

It should be understood that, in the present invention, “B corresponding to A”, “A corresponding to B”, “A corresponds to B”, or “B corresponds to A” means that B is associated with A and B can be determined in accordance with A. Determining B in accordance with A does not mean that B is determined only in accordance with A but means that B can be determined in accordance with A and/or other information. Matching between A and B means that the similarity between A and B is greater than or equal to a preset threshold.

Depending on the context, the term “if” as used herein may be interpreted as “when”, or “in the case that”, or “in response to a determination”, or “in response to a detection”.

The technical solutions of the present invention will be described in detail with reference to specific embodiments. The following specific embodiments can be combined with each other, and the same or similar concepts or processes may not be elaborated in some embodiments.

### Embodiment 1

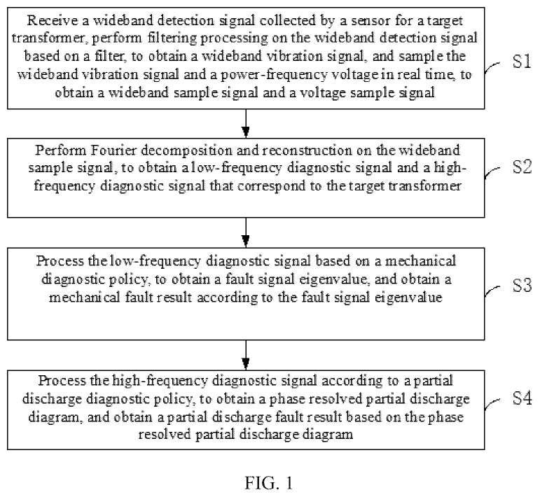

As shown in FIG. 1, the present invention provides an evaluation method for judging an electromechanical state of a transformer using a wideband vibration feature, including steps S1 to S4:

S1: receiving a wideband detection signal collected by a sensor for a target transformer, performing filtering processing on the wideband detection signal based on a filter, to obtain a wideband vibration signal, and sampling the wideband vibration signal and a power-frequency voltage in real time, to obtain a wideband sample signal and a voltage sample signal.

It should be noted that, a measurement device of the wideband vibration signal may be an HS-10A-11M2 acoustic transmission vibration complex sensor of Fuji. Sensitivity of an ultrasonic sensor thereof is about 80 dB, and a frequency range is from 50 kHz to 200 kHz, which includes a main band of partial discharge in oil. A vibration signal sensor is an IEPE sensor and needs constant current power supply. Sensitivity is about 100 mV/g, and a frequency range is from 10 Hz to 20 kHz, meeting a requirement of vibration measurement.

It may be understood that a server may receive the wideband detection signal collected by the sensor for the target transformer, perform filtering processing on the wideband detection signal based on the filter, to obtain the wideband vibration signal, and sample the wideband vibration signal and the power-frequency voltage in real time, to obtain the wideband sample signal and the voltage sample signal.

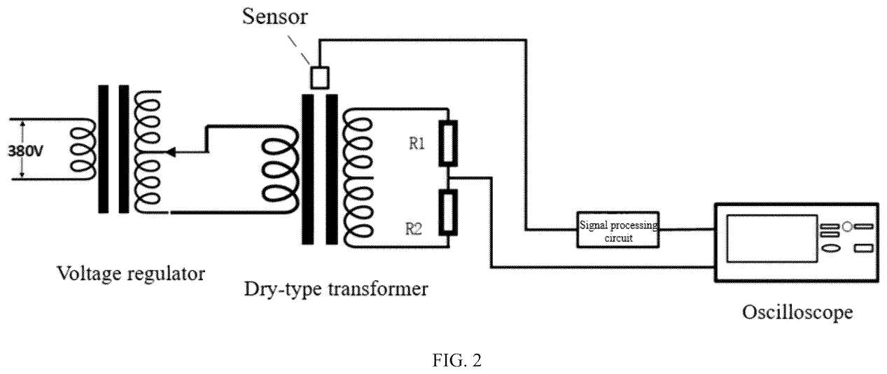

During monitoring, a wideband vibration signal of a dry-type transformer may be collected. For example, an SCB11-100/10 type of dry-type transformer performs transformer mechanical fault and partial discharge ultrasonic detection experiments. The transformer is shown in FIG. 2, a rated capacity is 100 kVA, and a rated voltage is 10 kV. During measurement, a magnetic attraction clamp may be used to fix a wideband vibration sensor to a transformer tank body for measurement.

In addition, for a measured wideband vibration signal, the filter is used to perform low-pass filtering of 200 kHz on the measured wideband vibration signal, to remove an interference signal, to obtain a filtering signal (that is, the wideband vibration signal), and the wideband vibration signal and a power-frequency voltage at this time are sampled through a signal processing circuit.

S2: performing Fourier decomposition and reconstruction on the wideband sample signal, to obtain a low-frequency diagnostic signal and a high-frequency diagnostic signal that correspond to the target transformer.

It may be understood that the server may perform the Fourier decomposition and reconstruction on the wideband sample signal, to obtain the low-frequency diagnostic signal and the high-frequency diagnostic signal that correspond to the target transformer.

The Fourier decomposition and reconstruction are performed on the wideband vibration signal, to decompose the wideband vibration signal into a low-frequency vibration signal of 10 Hz to 20 kHz and a high-frequency ultrasonic signal of 50 kHz to 200 kHz. The low-frequency vibration signal is used for mechanical fault diagnosis, and the high-frequency ultrasonic signal is combined with a voltage signal at this time for partial discharge diagnosis. The Fourier decomposition and reconstruction herein are the prior art and are not described in detail herein.

S3: processing the low-frequency diagnostic signal based on a mechanical diagnostic policy, to obtain a fault signal eigenvalue, and obtaining a mechanical fault result according to the fault signal eigenvalue.

In some embodiments, the processing the low-frequency diagnostic signal based on a mechanical diagnostic policy, to obtain a fault signal eigenvalue, and obtaining a mechanical fault result according to the fault signal eigenvalue in step S3 includes S31 to S34:

S31: using the low-frequency diagnostic signal as an input signal of the target transformer.

It may be understood that the server will decompose the obtained low-frequency vibration signal of 10 Hz to 20 kHz and introduce a vibration signal analysis technology to perform eigenmode decomposition on the sampling signal.

S32: extracting a non-extremum point in the low-frequency diagnostic signal, and calculating, based on the non-extremum point and the input signal, an extremum point signal corresponding to an extremum point in the low-frequency diagnostic signal.

In some embodiments, the calculating, based on the non-extremum point and the input signal, an extremum point signal corresponding to an extremum point in the low-frequency diagnostic signal in step S32 includes:
obtaining the extremum point signal through the following formula:

$$R ( t ) = f ( t ) - f ( {t}_{j} )$$

where R(t) is the extremum point signal, f(t) is the input signal of the target transformer, and f(tⱼ) is a signal corresponding to a sampling time of the non-extremum point.

It is not difficult to understand that, assuming that a collected vibration signal is an input signal during decomposition, an extremum point in the signal is calculated, and an extremum point in a corresponding signal is extracted.

S33: converting the extremum point signal based on a linear conversion manner, to obtain a signal residual amount, and calculating the signal residual amount, to obtain decomposition of an intrinsic mode.

Subsequently, the extremum point signal is converted by using the linear conversion manner in the vibration signal analysis technology, to obtain the signal residual amount.

In some embodiments, the converting the extremum point signal based on a linear conversion manner, to obtain a signal residual amount in step S33 includes: obtaining the signal residual amount through the following formula:

$$r ( t ) = R ( t ) + [ R ( {t}_{j + 1} ) - R ( {t}_{j} ) ]$$

where r(t) is a residual amount obtained after the extremum point signal is converted, R(tⱼ₊₁) is an extremum point corresponding to a j+1^{th} low-frequency diagnostic signal, and R(tⱼ) is an extremum point corresponding to a j^{th} low-frequency diagnostic signal.

In some embodiments, the calculating the signal residual amount, to obtain decomposition of an intrinsic mode in step S33 includes:
obtaining the decomposition of the intrinsic mode through the following formula:

$$α = r ( t ) \times {P}_{i - 1} \times {P}_{i} \times γ$$

where α is decomposition of an intrinsic mode of a vibration signal, Pᵢ₋₁ is a sinusoidal signal component corresponding to an i−1^{th} sampling point, Pᵢ is a cosine signal component corresponding to an i^{th} sampling point, and γ is a coordinate of a control point.

S34: performing calculation according to the decomposition of the intrinsic mode, to obtain the fault signal eigenvalue, and obtaining the mechanical fault result according to the fault signal eigenvalue.

In some embodiments, the performing calculation according to the decomposition of the intrinsic mode, to obtain the fault signal eigenvalue in step S34 includes:
performing vibration eigenvalue selection on a decomposed vibration signal eigenmode. A fundamental vibration ratio is used as a reference to extract a fault eigenvalue.
obtaining the fault signal eigenvalue through the following formula:

$$K = \frac{A \times α}{{\sum }_{i > 1}^{n} {L}_{i}^{2}}$$

where K is a fault eigenvalue of the vibration signal, A is an amplitude of a frequency point, Lᵢ is a harmonic content in an i^{th} low-frequency diagnostic signal, and n an upper limit value of a quantity of low-frequency diagnostic signals.

The strength of the vibration signal is monitored in a fault point region, and when a high-strength vibration signal is monitored, a large transformer is arranged to operate a vibration signal monitoring platform for collecting the vibration signal.

In some embodiments, the obtaining the mechanical fault result according to the fault signal eigenvalue in step S34 includes:
when it is judged that the fault signal eigenvalue is greater than 10, generating a severe mechanical fault result.

When it is determined that the fault signal eigenvalue is less than 5, a mild mechanical fault result is generated.

When it is determined that the fault signal eigenvalue is greater than and equal to 5 and is less than and equal to 10, a repeated verification result is generated to be sent to a management end.

It is not difficult to understand that if K>10, a severe mechanical fault occurs in the transformer.

If K<5, a mild mechanical fault occurs in the transformer and does not affect a normal operation of the transformer.

If 5≤K≤10, measurement needs to be performed for a plurality of times, to exclude a measurement error caused by accidental factors such as artificial measurement.

S4: processing the high-frequency diagnostic signal according to a partial discharge diagnostic policy, to obtain a phase resolved partial discharge diagram, and obtaining a partial discharge fault result based on the phase resolved partial discharge diagram.

In some embodiments, the processing the high-frequency diagnostic signal according to a partial discharge diagnostic policy, to obtain a phase resolved partial discharge diagram in step S4 includes S41 to S44:

S41: processing the high-frequency diagnostic signal based on a high-frequency envelope detection circuit, to obtain an ultrasonic detection signal.

It may be understood that after obtaining the high-frequency ultrasonic signal of 50 kHz to 200 kHz, the server may extract an envelope curve of an ultrasonic signal generated by partial discharge through the high-frequency envelope detection circuit, remove a high-frequency carrier component in the input signal, and only retain an amplitude and an occurrence time of a signal maximum value, thereby reducing a sampling rate requirement and a data amount of the ultrasonic signal.

S42: obtaining a maximum amplitude of the ultrasonic signal according to the ultrasonic detection signal, and determining a voltage phase corresponding to the maximum amplitude as an amplitude phase.

It should be noted that when the electromechanical state of the transformer is evaluated, although the PRPD (Phase Resolved Partial Discharge) diagram generated through a subsequent direct record is an intuitive manner, the diagram may not be sufficient to comprehensively reflect a mechanical state and an insulation state of the transformer. This is because the ultrasonic signal generated by partial discharge not only includes discharge amplitude information, but also includes time sequence information related to the voltage phase. These pieces of information are crucial for accurately judging a discharge type (for example, floating potential discharge, point discharge, or surface discharge).

First, the low-frequency vibration signal and the high-frequency ultrasonic signal are collected simultaneously through a complex sensor because the two signals respectively reflect different states of a mechanical portion and an insulation portion of the transformer. The low-frequency vibration signal is mainly used to diagnose a mechanical fault, and the high-frequency ultrasonic signal is closely related to an insulation fault, particularly the partial discharge.

Then, envelope detection processing is performed on the high-frequency ultrasonic signal, to extract the envelope curve generated by the partial discharge in a complicated ultrasonic signal. This envelope curve reflects a maximum amplitude of a discharge signal and a change trend thereof over time (or the voltage phase). In this way, there are benefits of simplifying the signal and removing the high-frequency carrier component, so that subsequent analysis is more focused on a discharge essential characteristic.

Then, an amplitude of a maximum value of the ultrasonic signal corresponds to the voltage phase because the occurrence of the partial discharge usually has a close relationship with the voltage phase. The PRPD diagram may be constructed by recording a maximum amplitude of each discharge signal and a voltage phase corresponding to the maximum amplitude. This diagram may clearly show a distribution of a discharge point within a voltage period, thereby providing an important evidence for judging the discharge type.

Finally, the insulation state of the transformer, whether there is the partial discharge, the discharge type, and a discharge severe degree may be accurately judged by analyzing a feature parameter of the PRPD diagram, for example, a distribution relationship of the discharge point with a phase, and a distribution relationship of the discharge point with an amplitude of the ultrasonic signal.

S43: constructing a phase resolved initial discharge diagram, where the phase resolved initial discharge diagram has a discharge coordinate system, a horizontal axis of the discharge coordinate system is the voltage phase, and a vertical axis thereof is the amplitude of the ultrasonic signal.

S44: counting the maximum amplitude and the amplitude phase based on a preset time period, to obtain a plurality of discharge coordinates, and constructing a discharge coordinate point in the discharge coordinate system based on the discharge coordinates, to obtain the phase resolved partial discharge diagram.

It may be understood that for the obtained envelope curve, an upper envelope of the ultrasonic signal and a voltage phase signal are combined, to obtain the amplitude of the maximum value of the ultrasonic signal and a corresponding voltage phase. Amplitudes and phases, generated within ten seconds, of all ultrasonic signals are recorded, and the PRPD diagram is drawn. A horizontal axis of a coordinate axis is the voltage phase, and a vertical axis thereof is the amplitude of the ultrasonic signal and a relative amplitude of an applied voltage.

Therefore, although the PRPD diagram generated through a direct record seems simple, actually, the insulation state of the transformer may be reflected more comprehensively and accurately by first extracting a corresponding relationship between the amplitude of the maximum value of the ultrasonic signal and the voltage phase and then recording all the ultrasonic signals and drawing the PRPD diagram, thereby improving accuracy and reliability of fault diagnosis.

In some embodiments, the obtaining a partial discharge fault result based on the phase resolved partial discharge diagram in step S4 includes:
dividing the phase resolved partial discharge diagram based on a voltage phase angle of 10°, to obtain a plurality of phase intervals.

It may be understood that the voltage phase angle of 10° is used as an interval for counting, which means that the entire voltage period (generally) 360° is divided into 36 aequilatus intervals, and each interval covers a phase angle of 10°.

A quantity of discharge coordinate points in each of the phase intervals is counted, to obtain a discharge interval quantity, and a quantity of all discharge coordinate points in the phase resolved partial discharge diagram is counted, to obtain a total discharge quantity.

It may be understood that for a relationship between the discharge point distribution and the voltage phase, in each phase interval of 10°, an occurred discharge quantity is counted.

A discharge ratio is obtained according to a ratio of the discharge interval quantity to the total discharge quantity, and a quantity of discharge intervals with the discharge ratio greater than and equal to 4% is counted, to obtain an interval accumulation quantity.

It may be understood that, for each phase interval, a percentage of a discharge quantity of the phase interval to a total discharge quantity in the entire statistical period is calculated.

An accumulative judgment interval is obtained based on a product of the interval accumulation quantity and 10°, and when it is determined that the accumulative judgment interval is greater than 120°, a floating potential discharge fault result is generated.

It may be understood that if a ratio of a discharge quantity of a certain interval reaches or exceeds 4%, this interval is considered to be “significant”, that is, a discharge activity is relatively frequent in the phase interval.

These “significant” phase intervals are further observed, that is, intervals with the ratio of the discharge quantity≥4%.

If the width of total phase angles of these significant intervals is greater than 120°, this condition is met.

According to the above statistical results, if a condition that “a significant phase interval is greater than 120°” is met, it is judged to be a floating potential discharge fault. This is because floating potential discharge generally shows a higher discharge activity in a specific phase interval, and these intervals may span a wide phase range.

For example, the voltage phase angle of 10° is used as an interval for counting a relationship between the discharge point distribution and the voltage phase in the PRPD diagram, and if a phase interval with the ratio of the discharging quantity≥4% is greater than 120°, it is judged to be the floating potential discharge fault.

In some embodiments, the obtaining a partial discharge fault result based on the phase resolved partial discharge diagram in step S4 includes:
invoking a preset gap voltage, and determining a plurality of voltage judgment intervals at a horizontal axis in the phase resolved partial discharge diagram based on the preset gap voltage and a preset quantity.

It should be noted that according to the present invention, the preset gap voltage may be preset, and the plurality of voltage judgment intervals at the horizontal axis in the phase resolved partial discharge diagram may be determined subsequently based on the preset gap voltage and the preset quantity.

Since the amplitude of the ultrasonic signal measured by the sensor is related to a gain of a signal amplifier and a range of the sensor, on the premise of the sensor used in the present invention, for example, 0.5 V is used as an interval for analyzing a distribution regularity of the discharge point with the signal amplitude.

A minimum voltage judgment interval is selected as a floating judgment interval, and the rest of voltage judgment intervals are used as change rate judgment intervals.

It may be understood that the change rate judgment intervals are based on 0.5 V, which are [0.5, 1) and [1, 1.5), and [1, 1.5) and [1.5, 2) respectively.

When it is determined that an amplitude of a discharge coordinate point in the phase resolved partial discharge diagram is in the floating judgment interval, the floating potential discharge fault result is generated.

For example, if amplitudes of all discharge points are in an interval [0, 0.5), the floating potential discharge fault occurs.

A change rate of a corresponding quantity of discharge coordinate points in the change rate judgment interval is calculated.

According to the present invention, a calculation method of a change rate λi is as follows:

$$\{ \begin{matrix}{λ}_{1} & = \frac{{N}_{[ 0.5 , 1 )} - {N}_{[ 1 , 1.5 )}}{{N}_{[ 1 , 1.5 )}} \\ {λ}_{2} & = \frac{{N}_{[ 1 , 1.5 )} - {N}_{[ 1.5 , 2 )}}{{N}_{[ 1.5 , 2 )}}\end{matrix}$$

where λᵢ is the change rate, and N [a, b) represents a quantity of discharge points in an interval [a, b).

When it is determined that the change rate is greater than 2, a point discharge fault result is generated.

For example, if change rates λ1 and λ2 of a quantity of discharging points in intervals [0.5, 1) and [1, 1.5), and [1, 1.5) and [1.5, 2)>2, a point discharge fault occurs.

When it is judged that the change rate is less than and equal to 2, a surface discharge fault result is generated.

If the change rates λ1 and λ2≤2, a surface discharge fault occurs.

### Embodiment 2

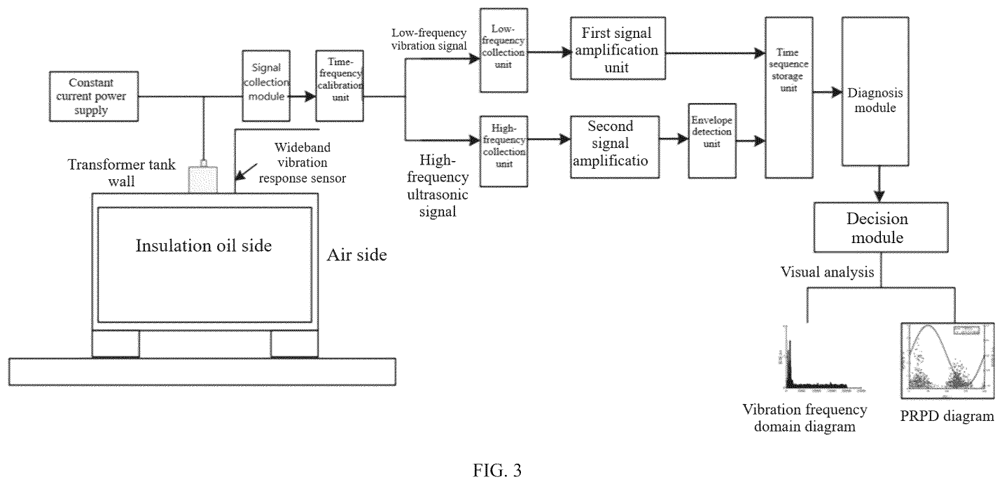

As shown in FIG. 3, an evaluation apparatus for an electromechanical state of a transformer is applicable to the above evaluation method for an electromechanical state of a transformer, configured to detect a transformer fault, and adapted to a multi-frequency sensor mounted on a transformer side. Specifically, the multi-frequency sensor is mounted on a transformer tank wall and is configured to send a wideband signal (specifically, a vibration signal and an ultrasonic signal) representing a state of the transformer to a transformer fault detection apparatus. The transformer fault detection apparatus is composed of a signal collection module, a signal processing module, and a signal diagnostic module. Specifically, the signal collection module is electrically connected to the signal processing module and is configured to collect a wideband signal of the multi-frequency sensor mounted on the transformer side. The signal processing module is electrically connected to the signal diagnostic module and is configured to perform time-frequency calibration on a collected wideband signal and adaptively adjust a frequency range and a storage time according to a signal feature of the wideband signal. The signal diagnostic module is electrically connected to a decision module and is configured to recognize a fault pattern on a corresponding band according to multi-dimension features of the wideband signal.

In the embodiment, the signal collection module is connected to the multi-frequency sensor mounted on the transformer side and is responsible for catching the wideband signal during an operation of the transformer in real time and with high precision. The wideband signal covers a wide range from a low frequency to a high frequency, which can comprehensively reflect an operation state of the transformer, including changes in various physical quantities such as vibration and sound. The signal processing module receives original data from the signal collection module and further performs complicated time-frequency calibration processing, to ensure signal accuracy and reliability. At the same time, the signal processing module can dynamically adjust a frequency monitoring range and a data storage policy according to a feature of a received wideband signal and effectively respond to signal changes of the transformer under different working conditions, to improve sensitivity and accuracy of fault detection. The signal diagnostic module performs deep analysis on a processed signal and extracts the multi-dimension features such as a frequency, an amplitude, a phase, and an energy distribution, to recognize the fault pattern on the corresponding band. Accuracy and an early warning capability of fault detection can be significantly improved through multi-dimension analysis. According to the present application, dynamic feature analysis and an adaptive learning technology are combined to provide strong technical support for secure and efficient operations of the transformer.

It may be understood that, in combination with an actual working condition of the transformer, a collection range and a precision specification of a state parameter of the transformer are as follows: a. Vibration signal measurement: a frequency range: the sensor should at least cover a frequency range of 10 Hz to 1000 Hz, to catch a common low-frequency mechanical vibration during the operation of the transformer. Sensitivity: sensitivity of the sensor should be greater than 50 mV/g, to ensure that a tiny vibration signal can be detected, thereby improving precision of fault detection. b. Ultrasonic signal measurement: a frequency range: the sensor should at least cover a frequency range of 100 kHz to 200 kHz, and the band is a main ultrasonic signal band generated by partial discharge (PD) in oil, which can effectively reflect existence and a severe degree of an insulation defect. Sensitivity: sensitivity of the ultrasonic signal should be greater than 80 dB, to ensure a sufficient detection capability for a weak partial discharge signal, thereby improving sensitivity and reliability of fault recognition.

In combination with the above sampling standards of the state parameter of the transformer, the multi-frequency sensor used in the embodiment may be, for example, an HS-10A-11M2 ultrasonic transmission vibration complex sensor of Fuji of Japan. The sensor may measure the vibration signal and the ultrasonic signal simultaneously. A constant current power source provides stable current power supply for the ultrasonic transmission vibration complex sensor, to ensure a stable operation of the sensor. Sensitivity of the ultrasonic sensor is about 80 dB, and a frequency range is from 50 kHz to 200 kHz, including a main band of partial discharge in oil. A vibration signal sensor is an IEPE sensor and needs constant current power supply, sensitivity is about 100 mV/g, and a frequency range is from 10 Hz to 20 kHz, meeting a requirement of vibration measurement.

As a preferred solution of the embodiment, the signal collection module includes a low-frequency signal collection unit responding to a mechanical vibration signal and a high-frequency signal collection unit responding to an ultrasonic signal.

In the embodiment, a mechanical vibration is an important reflection of a mechanical structure state in the transformer, for example, a loose winding, a deformed core, and another abnormality may cause a specific vibration pattern. It is assumed that in an actual scenario, the transformer is operated at a rated frequency of 50 Hz, and the low-frequency signal collection unit can precisely catch a low-frequency signal generated by the mechanical vibration and having a frequency range between tens of Hz and hundreds of Hz. These signals are converted into electrical signals through a high-precision sensor and are transmitted to the low-frequency signal collection unit in real time for subsequent analysis. The high-frequency signal collection unit mainly responds to an ultrasonic signal that may be generated in the transformer. Generally, the ultrasonic signal is closely related to phenomena such as an insulation state and partial discharge of the transformer. For example, when the partial discharge occurs in the transformer, a high-frequency ultrasonic wave signal may be generated. The high-frequency signal collection unit can detect these ultrasonic signals whose frequencies are generally between thousands of Hz and hundreds of kHz. In actual application, if the partial discharge occurs at a certain position in the transformer, the high-frequency signal collection unit may rapidly catch this abnormal signal and provide key information for subsequent fault diagnosis.

As a preferred solution of the embodiment, the signal processing module includes a time-frequency calibration unit, a frequency adjustment unit, and a time sequence storage unit;
the time-frequency calibration unit adjusts sampling times of the low-frequency signal collection unit and the high-frequency signal collection unit according to a time domain adjustment factor and a frequency domain adjustment factor to obtain a time-frequency domain synchronization signal;
the frequency adjustment unit adaptively adjusts a corresponding frequency signal in response to the time-frequency domain synchronization signal to obtain a target state signal;
the time sequence storage unit stores the target state signal to a corresponding storage position according to a synchronization mark of the time-frequency domain synchronization signal; and
the target state signal includes a low-frequency diagnostic signal and a high-frequency diagnostic signal.

In the embodiment, to optimize efficiency and accuracy of signal processing, the sampling times of the low-frequency signal collection unit and the high-frequency signal collection unit are finely adjusted according to the preset time domain adjustment factor and frequency domain adjustment factor. The time domain adjustment factor focuses on time synchronization, to ensure that signals of different frequencies remain consistent in time, while the frequency domain adjustment factor is responsible for adjusting a frequency characteristic of the signals, to eliminate a frequency deviation that may be caused by a difference in a collection device or an environmental factor. The time-frequency calibration unit can generate the time-frequency domain synchronization signal, so that low-frequency and high-frequency signals reach a high degree of synchronization in both time and frequency, laying a solid foundation for subsequent processing. After receiving the time-frequency domain synchronization signal, the frequency adjustment unit adaptively adjusts frequencies of these synchronized signals based on a specific characteristic of the signal, for example, an amplitude, a phase, or a spectrum characteristic, to meet a specific analysis or diagnostic requirement, so that an original signal is converted into the target state signal. The target state signal includes the low-frequency diagnostic signal and the high-frequency diagnostic signal, which respectively correspond to different frequency ranges and analysis key points. Finally, the time sequence storage unit is responsible for storing a processed target state signal according to the synchronization mark in the time-frequency domain synchronization signal. The synchronization mark is the key to ensuring that the signal is stored in a correct time sequence and allows subsequent data analysis or playback to accurately reconstruct a time sequence of the original signal. The low-frequency diagnostic signal and the high-frequency diagnostic signal are respectively stored to corresponding storage positions, so that the time sequence storage unit not only ensures data organization, but also provides convenience for subsequent data retrieval and processing. The signal processing module in the embodiment implements efficient and precise processing on the low-frequency and high-frequency signals through close cooperation of three links of time-frequency calibration, frequency adjustment, and time sequence storage, which not only improves accuracy and reliability of signal processing, but also provides a high-quality data foundation for subsequent data analysis and fault diagnosis.

As a further illustrative description for the above embodiment, for the low-frequency signal collection unit, an original sampling time thereof is tL. A sampling time adjusted by the time-frequency calibration unit may be represented as: tL_sync=tL+Tadj_L, where Tadj_L is a time domain adjustment factor of the low-frequency signal. For the high-frequency signal collection unit, an original sampling time thereof is tH. A sampling time adjusted by the time-frequency calibration unit may be represented as: tH_sync=tH+Tadj_H, where Tadj_H is a time domain adjustment factor of the high-frequency signal. The frequency adjustment unit receives the time-frequency domain synchronization signal and adaptively adjusts a signal of a corresponding frequency according to the signal, to obtain the target state signal (including the low-frequency diagnostic signal and the high-frequency diagnostic signal). The time sequence storage unit accurately stores the target state signal to a corresponding storage position according to the synchronization mark in the time-frequency domain synchronization signal.

As a preferred solution of the embodiment, the frequency adjustment unit includes a high-frequency adjustment unit and a low-frequency adjustment unit; the high-frequency adjustment unit responds to an ultrasonic signal in the time-frequency domain synchronization signal; and the low-frequency adjustment unit responds to a mechanical vibration signal in the time-frequency domain synchronization signal. Further, the frequency adjustment unit further includes a signal amplification unit. Specifically, an output end of the low-frequency adjustment unit is equipped with a first signal amplification unit, an output end of the high-frequency adjustment unit is equipped with a second signal amplification unit, and the first signal amplification unit and the second signal amplification unit both are constructed by using a T-type resistance feedback network charge amplification circuit.

In the embodiment, for the vibration signal and the ultrasonic signal obtained through the signal processing module, a signal to noise ratio is lower, and reliability is stronger. Due to a relatively small semaphore, a charge amplifier is accessed, and a charge signal enters an amplification circuit through an input end of the charge amplifier. Due to a low lower limit cut-off frequency of the wideband vibration signal, to avoid a signal loss after amplification, the signal amplification unit in the present invention introduces a T-type resistance feedback network charge conversion solution. The T-type resistance feedback network charge amplification circuit belongs to a conventional technology in the art and is not described in detail herein.

As a preferred solution of the embodiment, the frequency adjustment unit further includes an envelope detection unit that performs upper envelope detection on the ultrasonic signal.

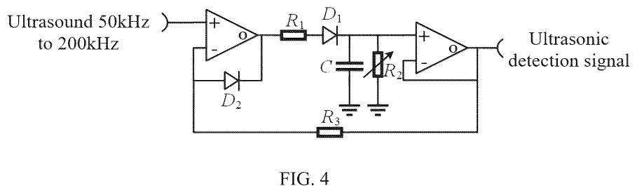

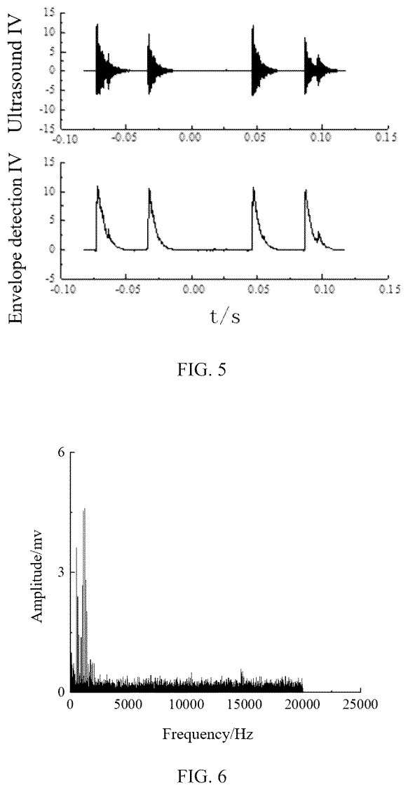

In the embodiment, during measurement of the ultrasonic signal, although direct measurement can obtain rich signal information, in partial discharge analysis, it is only necessary to extract the amplitude and time of the ultrasonic signal generated by the partial discharge. To simplify signal processing, the present invention uses an envelope detection circuit to perform upper envelope detection on the ultrasonic signal, to ensure a peak value of the ultrasonic signal and a corresponding time to remain unchanged and effectively reduce a requirement of a sampling rate to about 10 kHz at the same time, thereby reducing power consumption and memory occupation of a detection apparatus, to accurately collect the peak value and the time of the ultrasonic signal under a low sampling rate. FIG. 4 is a schematic diagram of a detection circuit. Specifically, negative input ends of two comparison elements of the detection circuit are communicated. A positive input end of a first comparison element obtains the ultrasonic signal, and a frequency range of the ultrasonic signal is from 50 kHz to 200 kHz. A negative input end of the first comparison element is electrically connected to a positive pole end of a diode D2, an output end of the first comparison element is electrically connected to a negative pole end of the diode D2, the output end of the first comparison element is electrically connected to a positive pole end of a diode D1 through a resistor R1, and a negative pole end of the diode D1 is connected to the ground through a capacitor C, is connected to the ground through a variable resistor R2, and is communicated with a positive input end of a second comparison element. An output end of the second comparison element outputs an ultrasonic detection signal, and an effect diagram of a detection signal is shown in FIG. 5.

As a preferred solution of the embodiment, the signal diagnostic module includes a frequency domain feature extraction unit, a time domain feature extraction unit, a time-frequency domain feature extraction unit, and an envelope analysis unit; and the signal diagnostic module determines a corresponding unit combination pattern in response to a frequency range of the target state signal to generate a corresponding fault pattern.

Further, the signal diagnostic module determines a corresponding unit combination pattern in response to a frequency range of the target state signal to generate a corresponding fault pattern includes the following steps:
extracting the low-frequency signal in the target state signal, and determining, by the time domain feature extraction unit, a first low-frequency fault pattern according to a mean value, a variance, a peak value, and kurtosis in the low-frequency signal;
analyzing, by the frequency domain feature extraction unit, spectrum energy, a center frequency, a bandwidth, and a harmonic component in the low-frequency signal according to Fourier transform to determine a second low-frequency fault pattern; and
determining a target low-frequency fault pattern according to the first low-frequency fault pattern and the second low-frequency fault pattern.

In the embodiment, since winding looseness or displacement may cause a periodic vibration or impact, particularly under an action of electromagnetic force when the transformer is operated, which is manifested as a periodic pulse in a time domain signal, with the aggravation of the fault, an amplitude of the pulse may increase, and a frequency of the pulse is usually related to a power frequency of a power grid. When the core is loose, a low-frequency vibration may occur in the time domain signal. Since a mechanical impact and electromagnetic force caused by the looseness of the core are not stable, the low-frequency vibration is obvious. The time domain feature extraction unit is configured to analyze a time domain characteristic of the vibration signal and extract a mean value, a variance, a peak value, kurtosis, and another statistical feature of the signal, to recognize a fluctuation trend and an abnormal impact of the signal. In frequency domain analysis, a main feature of the winding looseness or displacement is to present a significant vibration component at a power frequency and a multiplication frequency thereof, especially a harmonic signal of a twofold frequency and threefold frequency. With the aggravation of the fault, energy of a high-order harmonic wave is increased, and a high-frequency component in a spectrum is more obvious. Generally, core looseness or vibration fault presents an obvious vibration peak value at a low band (<100 Hz), and power frequency and frequency multiplication components may also be strengthened with the increase of the fault. The frequency domain feature extraction unit performs fast Fourier transform (FFT) on the signal and extracts spectrum energy, a center frequency, a bandwidth, a harmonic component, and another frequency domain feature, thereby recognizing a fault pattern on a specific frequency. Specifically, according to a time domain feature obtained through calculation, in combination with time domain manifestations of faults such as winding looseness or displacement and core looseness, it is judged whether there is a corresponding low-frequency fault pattern. For example, if the periodic pulse occurs in the signal, and the pulse amplitude is increased with the aggravation of the fault, for example, a slope of the increase of the amplitude exceeds a preset threshold, there may be a winding looseness or displacement fault. If the low-frequency vibration in the signal exceeds the preset threshold, there may be a core looseness fault. According to an extracted frequency feature, in combination with frequency domain manifestations of faults such as winding looseness or displacement and core looseness, it is judged that whether there is a corresponding low-frequency fault pattern. For example, if the significant vibration component is presented at the power frequency and a multiplication frequency thereof in the spectrum, especially the harmonic signal of a twofold frequency and threefold frequency, there may be the winding looseness or displacement fault. If the obvious vibration peak value is presented at the low band (<100 Hz), there may be the core looseness fault. According to judgment results of the first low-frequency fault pattern and the second low-frequency fault pattern, the target low-frequency fault pattern is determined by comprehensively considering time domain and frequency domain features. If judgment results of two fault patterns are consistent, the target low-frequency fault pattern is the fault. If judgment results of two fault patterns are inconsistent, further analysis is required or another diagnostic method is combined for confirmation.

Further, that the signal diagnostic module determines a corresponding unit combination pattern in response to a frequency range of the target state signal to generate a corresponding fault pattern further includes the following steps:
extracting the high-frequency signal in the target state signal, and extracting, by the envelope analysis unit, an envelope feature of the high-frequency signal through Hilbert transform and demodulation analysis to obtain modulation information and transient impact information to determine a first high-frequency fault pattern;
performing, by the frequency domain feature extraction unit, spectrum analysis on the high-frequency signal, and extracting a high-frequency component and a harmonic wave to recognize a high-frequency vibration source to determine a second high-frequency fault pattern;
obtaining, by the time-frequency domain feature extraction unit, a pulse amplitude and a voltage phase of the high-frequency signal on a set time scale to obtain a third high-frequency fault pattern; and
determining a target high-frequency fault pattern according to the first high-frequency fault pattern, the second high-frequency fault pattern, and the third high-frequency fault pattern.

In the embodiment, for the ultrasonic signal, a partial discharge fault is presented as a short-time spiking pulse signal in the time domain, has a large amplitude, is not obvious in periodicity, and is usually accompanied by randomness and aperiodicity. This spiking pulse has very short duration, but has a very high amplitude, which is presented as a transient impact signal. The envelope analysis unit extracts the envelope feature of the signal through Hilbert transform and demodulation analysis, to catch the modulation information and the transient impact. In the frequency domain, the partial discharge fault is presented as a significant increase of a high-band (>10 kHz) signal. Since duration of a discharge event is extremely short, a broadband noise signal may be generated in the spectrum. A high-frequency harmonic wave and a broadband noise spectrum that are caused by discharging generally occur in a high band. The frequency domain feature extraction unit performs spectrum analysis on the ultrasonic signal, extracts a high-frequency component and harmonic wave, and recognize a high-frequency vibration source. A voltage phase analysis unit performs analysis and data consolidation on an amplitude of each ultrasonic signal pulse and a corresponding voltage phase within a period of measurement time of the ultrasonic signal. Specifically, an amplitude of a high-frequency signal envelope extracted through Hilbert transform and demodulation analysis may reflect strength of the transient impact. During specific implementation, when an envelope amplitude exceeds the preset threshold, it is considered that there is a significant transient impact. A modulation frequency extracted from an envelope signal may reflect periodicity of the modulation information. If the modulation frequency is close to the power frequency of the power grid or a multiple thereof, a specific fault pattern may be indicated. The width of the short-time spiking pulse signal is also an important parameter for quantifying the transient impact. The narrower width of the pulse generally indicates a stronger impact. After spectrum analysis is performed on the high-frequency signal, for an extracted amplitude of a high-frequency component, a frequency range (for example, >10 kHz) may be set, and a total amplitude or an average amplitude of all frequency components in the range is calculated. An amplitude of a high-frequency harmonic component caused by discharging may reflect strength and frequency distribution of the harmonic wave. An amplitude of each order of harmonic wave may be calculated respectively, or a total harmonic distortion (THD) rate is calculated. The width of a spectrum of the high-frequency signal may reflect a frequency range of the broadband noise signal. The wider width of the spectrum generally indicates a more intense discharge event. On the set time scale, for an amplitude of each high-frequency signal pulse, an average amplitude, a maximum amplitude, and anther statistical magnitude of all pulses may be calculated. For a voltage phase corresponding to the amplitude of each high-frequency signal pulse, a scatter diagram or a histogram of the pulse amplitude and the voltage phase may be drawn, to analyze a relationship and a distribution regularity between the pulse amplitude and the voltage phase. If the relationship between the pulse amplitude and the voltage phase in a normal state is known, a phase difference in a current state is calculated, that is, a deviation degree between an actual phase and a normal phase. A larger phase difference generally indicates a severer fault. Weighted scoring is performed on the first high-frequency fault pattern, the second high-frequency fault pattern, and the third high-frequency fault pattern, and the target high-frequency fault pattern is judged comprehensively according to a scoring result.

As a further illustrative description for the above embodiment, for example:

$${text}_{total} = w 1 \times text 1 + w 2 \times text 2 + w 3 \times text 3 ,$$

where w1, w2, and w3 respectively are weights of the first, second, and third high-frequency fault pattern, and w1+w2+w3=1; and a wight of a fault pattern may be set according to significance and an occurrence frequency of an actual fault pattern.

A score of the first high-frequency fault pattern:

$$text 1 = {\sum }_{i = 1}^{n 1} ( {a}_{i} \times envelope {amplitude}_{i} + {b}_{i} \times modulation {frequency}_{i} + {c}_{i} \times pulse {width}_{i} ) ,$$

where n1° is a quantity of quantitative indexes of the first high-frequency fault pattern, and aᵢ, bᵢ, and cᵢ respectively are weight coefficients of the envelope amplitude, the modulation frequency, and the pulse width.

A score of the second high-frequency fault pattern:

$$text 2 = {\sum }_{j = 1}^{n 2} ( {d}_{j} \times high - frequency component {amplitude}_{j} + {e}_{j} \times harmonic component {amplitude}_{j} + {f}_{j} \times spectrum {width}_{j} )$$

$${text}_{total} = w 1 \times text 1 + w 2 \times text 2 + w 3 \times text 3 ,$$

where n2 is a quantity of quantitative indexes of the second high-frequency fault pattern, and dⱼ, eⱼ, and fⱼ respectively are weight coefficients of the high-frequency component amplitude, the harmonic component amplitude, and the spectrum width.

A score of the third high-frequency fault pattern:

$$text 3 = {\sum }_{k = 1}^{n 3} ( {g}_{k} \times pulse {amplitude}_{k} + {h}_{k} \times voltage phase {difference}_{k} )$$

where n3 is a quantity of quantitative indexes of the third high-frequency fault pattern, and gₖ and hₖ respectively are weight coefficients of the pulse amplitude and the voltage phase difference. It should be noted that the voltage phase difference is assumed to be an example quantitative index herein and may be quantified according to a specific condition of a phase difference if calculation is required in practice.

In the embodiment, the target high-frequency fault pattern is judged according to a total score obtained through calculation and a set threshold or range. For example, if the total score exceeds a certain threshold, it is considered that there is a specific severe high-frequency fault. If the total score is in a certain range, it is considered that there is a high-frequency fault of a certain degree. If the total score is less than a certain threshold, it is considered that a high-frequency signal is normal or a fault is not obvious.

### Embodiment 3

A structure is the same as that of Embodiment 2, and a difference lies in that the present application further includes a decision module, responding to a fault pattern and displaying a fault through a visual tool. The decision module includes a display unit and an alarm unit, and the display unit displays a target low-frequency fault pattern or/and a target high-frequency fault pattern through a vibration frequency domain diagram or/and a partial discharge PRPD diagram. The alarm unit sends a fault pattern of a target transformer to a remote platform or/and a mobile terminal.

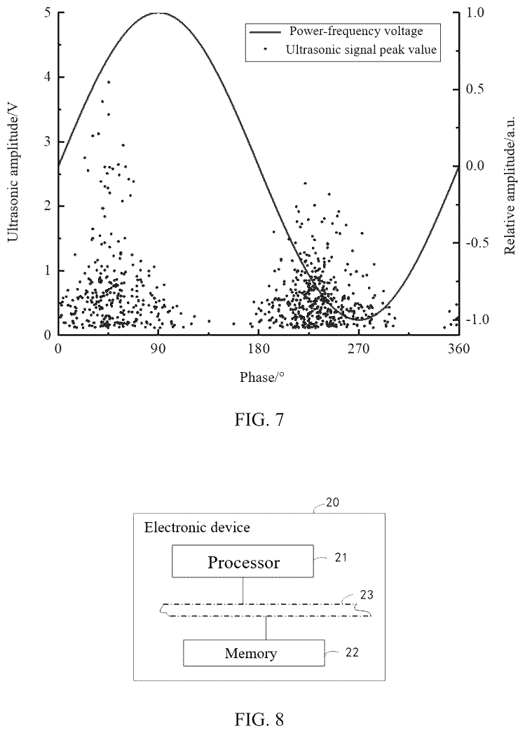

In the embodiment, the decision module performs visual analysis on the fault pattern. A carrier of the display unit may be the remote platform or the mobile terminal. The mobile terminal may be a terminal with display and data storage functions, for example, a computer, a mobile phone, and a pad, which is not limited in the present invention. The mobile terminal performs spectrum visual analysis on a vibration signal and performs partial discharge PRPD diagram visual analysis on an ultrasonic envelope signal and a voltage phase signal. For vibration spectrum analysis, since a transformer vibration generally is a multiplication frequency and a dividing frequency of 50 Hz and 100 Hz, when there is a mechanical fault, a vibration shape of a vibration signal obtained through collection may change, which indicates that contents of different frequency components in a frequency domain change. Therefore, as shown in FIG. 6, spectrum analysis is performed on vibration signals under different faults, to observe a change regularity of each frequency component. If a content of a certain component changes greatly, it is generally indicated that the mechanical fault occurs in a transformer. For partial discharge PRPD diagram analysis, a discharge point in the partial discharge PRPD diagram is drawn according to an amplitude of each ultrasonic signal pulse and a corresponding voltage phase at this time. As shown in FIG. 7, by analyzing the amplitude of each ultrasonic signal pulse and the corresponding voltage phase within a period of measurement time, a result is aggregated, which is a partial discharge PRPD diagram within the period of time. By analyzing discharge point distribution and features between voltage phases in the PRPD diagram, a type of partial discharge occurring in the transformer may be obtained through analysis, for example, floating potential discharge, needle-to-plate discharge, and surface discharge.

### Embodiment 4

FIG. 8 is a schematic structural diagram of hardware of an electronic device according to an embodiment of the present invention. The electronic device 20 includes: a processor 21, a memory 22, and a computer program.

The memory 22 is configured to store the computer program, and the memory may further be a flash memory. The computer program is, for example, an application or a functional module implementing the above method.

The processor 21 is configured to execute the computer program stored in the memory, to implement various steps executed by the device in the above method. Specifically, reference may be made to related descriptions in the foregoing method embodiments.

Optionally, the memory 22 may be independent or may be integrated with the processor 21.

When the memory 22 is a device independent of the processor 21, the device may further include:
a bus 23, configured to be connected to the memory 22 and the processor 21.

The present invention further provides a readable storage medium, a computer program is stored in the readable storage medium, and the computer program is configured to implement the method provided in the above implementations when executed by a processor.

The readable storage medium may be a computer storage medium or a communication medium. The communication medium includes any medium that enables a computer program to be transmitted from one place to another. The computer storage medium may be any available medium accessible to a general-purpose or a dedicated computer. For example, the readable storage medium is coupled to the processor, so that the processor can read information from the readable storage medium and write information to the readable storage medium. Certainly, the readable storage medium may alternatively be a component of the processor. The processor and the readable storage medium may be located in an application specific integrated circuit (ASIC). In addition, the ASIC may be located in a user device. Certainly, the processor and the readable storage medium may exist in a communication device as discrete components. The readable storage medium may be a read-only memory (ROM), a random access memory (RAM), a CD-ROM, a magnetic tape, a floppy disk, an optical data storage device, and the like.

The present invention further provides a program product. The program product includes an executable instruction, and the executable instruction is stored in the readable storage medium. At least one processor of the device may read the executable instruction from the readable storage medium, and the at least one processor executes the executable instruction to enable the device to implement the method provided by the above implementations.

In the embodiments of the above device, it should be understood that the processor may be a central processing unit (CPU), or may be another general-purpose processor, a digital signal processor (DSP), an application specific integrated circuit (ASIC), or the like. The general-purpose processor may be a microprocessor or the processor may also be any conventional processor or the like. Steps of the method disclosed with reference to the present invention may be directly executed and completed by a hardware processor, or may be executed and completed by using a combination of hardware and software modules in the processor.

Finally, it should be noted that the above embodiments are only used to illustrate the technical solutions of the present invention rather than limiting thereto. Although the present invention has been described in detail with reference to the foregoing embodiments, those of ordinary skill in the art should understand that the technical solutions recited in the foregoing embodiments may still be modified, or some or all of the technical features thereof may be replaced with equivalents. These modifications or replacements do not make the essence of the corresponding technical solution deviate from the scope of the technical solutions in the embodiments of the present invention.

What is claimed is:

1. An evaluation method for judging an electromechanical state of a transformer using a wideband vibration feature, comprising:
receiving a wideband detection signal collected by a sensor for a target transformer, performing filtering processing on the wideband detection signal based on a filter, to obtain a wideband vibration signal, and sampling the wideband vibration signal and a power-frequency voltage in real time, to obtain a wideband sample signal and a voltage sample signal;
performing Fourier decomposition and reconstruction on the wideband sample signal, to obtain a low-frequency diagnostic signal and a high-frequency diagnostic signal that correspond to the target transformer;
processing the low-frequency diagnostic signal based on a mechanical diagnostic policy, to obtain a fault signal eigenvalue, and obtaining a mechanical fault result according to the fault signal eigenvalue; and
processing the high-frequency diagnostic signal according to a partial discharge diagnostic policy, to obtain a phase resolved partial discharge diagram, and obtaining a partial discharge fault result based on the phase resolved partial discharge diagram.

2. The method according to claim 1, wherein
the processing the low-frequency diagnostic signal based on a mechanical diagnostic policy, to obtain a fault signal eigenvalue, and obtaining a mechanical fault result according to the fault signal eigenvalue comprises:
using the low-frequency diagnostic signal as an input signal of the target transformer;
extracting a non-extremum point in the low-frequency diagnostic signal, and calculating, based on the non-extremum point and the input signal, an extremum point signal corresponding to an extremum point in the low-frequency diagnostic signal;
converting the extremum point signal based on a linear conversion manner, to obtain a signal residual amount, and calculating the signal residual amount, to obtain decomposition of an intrinsic mode; and
performing calculation according to the decomposition of the intrinsic mode, to obtain the fault signal eigenvalue, and obtaining the mechanical fault result according to the fault signal eigenvalue.

3. The method according to claim 2, wherein
the calculating, based on the non-extremum point and the input signal, an extremum point signal corresponding to an extremum point in the low-frequency diagnostic signal comprises:
obtaining the extremum point signal through the following formula:
$$R ( t ) = f ( t ) - f ( {t}_{j} ) ,$$
wherein R(t) is the extremum point signal, f(t) is the input signal of the target transformer, and f(tⱼ) is a signal corresponding to a sampling time of the non-extremum point.

4. The method according to claim 3, wherein
the converting the extremum point signal based on a linear conversion manner, to obtain a signal residual amount comprises:
obtaining the signal residual amount through the following formula:
$$r ( t ) = R ( t ) + [ R ( {t}_{j + 1} ) - R ( {t}_{j} ) ] ,$$
wherein r(t) is a residual amount obtained after the extremum point signal is converted, R(tⱼ₊₁) is an extremum point corresponding to a j+1^{th} low-frequency diagnostic signal, and R(tⱼ) is an extremum point corresponding to a j^{th} low-frequency diagnostic signal.

5. The method according to claim 4, wherein
the calculating the signal residual amount, to obtain decomposition of an intrinsic mode comprises:
obtaining the decomposition of the intrinsic mode through the following formula:
$$α = r ( t ) \times {P}_{i - 1} \times {P}_{i} \times γ ,$$
wherein α is decomposition of an intrinsic mode of a vibration signal, Pᵢ₋₁ is a sinusoidal signal component corresponding to an i−1^{th} sampling point, Pᵢ is a cosine signal component corresponding to an i^{th} sampling point, and γ is a coordinate of a control point.

6. The method according to claim 5, wherein
the performing calculation according to the decomposition of the intrinsic mode, to obtain the fault signal eigenvalue comprises:
obtaining the fault signal eigenvalue through the following formula:
$$K = \frac{A \times α}{{\sum }_{i > 1}^{n} {L}_{i}^{2}} ,$$
wherein K is a fault eigenvalue of the vibration signal, A is an amplitude of a frequency point, Lᵢ is a harmonic content in an i^{th} low-frequency diagnostic signal, and n an upper limit value of a quantity of low-frequency diagnostic signals.

7. The method according to claim 6, wherein
the obtaining the mechanical fault result according to the fault signal eigenvalue comprises:
when it is judged that the fault signal eigenvalue is greater than 10, generating a severe mechanical fault result;
when it is determined that the fault signal eigenvalue is less than 5, generating a mild mechanical fault result; and
when it is determined that the fault signal eigenvalue is greater than and equal to 5 and is less than and equal to 10, generating a repeated verification result to be sent to a management end.

8. The method according to claim 1, wherein
the processing the high-frequency diagnostic signal according to a partial discharge diagnostic policy, to obtain a phase resolved partial discharge diagram comprises:
processing the high-frequency diagnostic signal based on a high-frequency envelope detection circuit, to obtain an ultrasonic detection signal;
obtaining a maximum amplitude of an ultrasonic signal according to the ultrasonic detection signal, and determining a voltage phase corresponding to the maximum amplitude as an amplitude phase;
constructing a phase resolved initial discharge diagram, wherein the phase resolved initial discharge diagram has a discharge coordinate system, a horizontal axis of the discharge coordinate system is the voltage phase, and a vertical axis thereof is an amplitude of the ultrasonic signal; and
counting the maximum amplitude and the amplitude phase based on a preset time period, to obtain a plurality of discharge coordinates, and constructing a discharge coordinate point in the discharge coordinate system based on the discharge coordinates, to obtain the phase resolved partial discharge diagram.

9. The method according to claim 7, wherein
the obtaining a partial discharge fault result based on the phase resolved partial discharge diagram comprises:
dividing the phase resolved partial discharge diagram based on a voltage phase angle of 10°, to obtain a plurality of phase intervals;
counting a quantity of discharge coordinate points in each of the phase intervals, to obtain a discharge interval quantity, and counting a quantity of all discharge coordinate points in the phase resolved partial discharge diagram, to obtain a total discharge quantity;
obtaining a discharge ratio according to a ratio of the discharge interval quantity to the total discharge quantity, and counting a quantity of discharge intervals with the discharge ratio greater than and equal to 4%, to obtain an interval accumulation quantity; and
obtaining an accumulative judgment interval based on a product of the interval accumulation quantity and 10°, and when it is determined that the accumulative judgment interval is greater than 120°, generating a floating potential discharge fault result.

10. The method according to claim 7, wherein
the obtaining a partial discharge fault result based on the phase resolved partial discharge diagram comprises:
invoking a preset gap voltage, and determining a plurality of voltage judgment intervals at a horizontal axis in the phase resolved partial discharge diagram based on the preset gap voltage and a preset quantity;
selecting a minimum voltage judgment interval as a floating judgment interval, and using the rest of voltage judgment intervals as change rate judgment intervals;
when it is determined that an amplitude of a discharge coordinate point in the phase resolved partial discharge diagram is in the floating judgment interval, generating a floating potential discharge fault result;
calculating a change rate of a corresponding quantity of discharge coordinate points in the change rate judgment interval;
when it is determined that the change rate is greater than 2, generating a point discharge fault result; and
when it is judged that the change rate is less than and equal to 2, generating a surface discharge fault result.

11. An evaluation apparatus for an electromechanical state of a transformer, adapted to a multi-frequency sensor mounted on a transformer side, comprising: a signal collection module, a signal processing module, and a signal diagnostic module, wherein
the signal collection module is electrically connected to the signal processing module and is configured to collect a wideband signal of the multi-frequency sensor mounted on the transformer side;
the signal processing module is electrically connected to the signal diagnostic module and is configured to perform time-frequency calibration on a collected wideband signal and adaptively adjust a frequency range and a storage time according to a signal feature of the wideband signal, to obtain a low-frequency diagnostic signal and a high-frequency diagnostic signal; and
the signal diagnostic module is electrically connected to a decision module and is configured to recognize a fault pattern on a corresponding band according to multi-dimension features of the low-frequency diagnostic signal and the high-frequency diagnostic signal.

12. The evaluation apparatus for an electromechanical state of a transformer according to claim 11, wherein
the signal collection module comprises a low-frequency signal collection unit responding to a mechanical vibration signal and a high-frequency signal collection unit responding to an ultrasonic signal.

13. The evaluation apparatus for an electromechanical state of a transformer according to claim 11, wherein
the signal processing module comprises a time-frequency calibration unit, a frequency adjustment unit, and a time sequence storage unit;
the time-frequency calibration unit adjusts sampling times of the low-frequency signal collection unit and the high-frequency signal collection unit according to a time domain adjustment factor and a frequency domain adjustment factor to obtain a time-frequency domain synchronization signal;
the frequency adjustment unit adaptively adjusts a corresponding frequency signal in response to the time-frequency domain synchronization signal to obtain a target state signal;
the time sequence storage unit stores the target state signal to a corresponding storage position according to a synchronization mark of the time-frequency domain synchronization signal; and
the target state signal comprises the low-frequency diagnostic signal and the high-frequency diagnostic signal.

14. The evaluation apparatus for an electromechanical state of a transformer according to claim 13, wherein
the frequency adjustment unit comprises a high-frequency adjustment unit and a low-frequency adjustment unit; the high-frequency adjustment unit responds to an ultrasonic signal in the time-frequency domain synchronization signal; and the low-frequency adjustment unit responds to a mechanical vibration signal in the time-frequency domain synchronization signal.

15. The evaluation apparatus for an electromechanical state of a transformer according to claim 14, wherein the frequency adjustment unit further comprises a signal amplification unit, and the signal amplification unit is constructed using a T-type resistance feedback network charge amplification circuit.

16. The evaluation apparatus for an electromechanical state of a transformer according to claim 14, wherein
the frequency adjustment unit further comprises an envelope detection unit that performs upper envelope detection on the ultrasonic signal.

17. The evaluation apparatus for an electromechanical state of a transformer according to claim 13, wherein
the signal diagnostic module comprises a frequency domain feature extraction unit, a time domain feature extraction unit, a time-frequency domain feature extraction unit, and an envelope analysis unit; and the signal diagnostic module determines a corresponding unit combination pattern in response to frequency ranges of the low-frequency diagnostic signal and the high-frequency diagnostic signal to generate a corresponding fault pattern.

18. The evaluation apparatus for an electromechanical state of a transformer according to claim 17, wherein
that the signal diagnostic module determines a corresponding unit combination pattern in response to frequency ranges of the low-frequency diagnostic signal and the high-frequency diagnostic signal to generate a corresponding fault pattern comprises the following steps:
extracting the low-frequency diagnostic signal in the target state signal, and determining, by the time domain feature extraction unit, a first low-frequency fault pattern according to a mean value, a variance, a peak value, and kurtosis in the low-frequency diagnostic signal;
analyzing, by the frequency domain feature extraction unit, spectrum energy, a center frequency, a bandwidth, and a harmonic component in the low-frequency diagnostic signal according to Fourier transform to determine a second low-frequency fault pattern; and
determining a target low-frequency fault pattern according to the first low-frequency fault pattern and the second low-frequency fault pattern.

19. The evaluation apparatus for an electromechanical state of a transformer according to claim 17, wherein
that the signal diagnostic module determines a corresponding unit combination pattern in response to frequency ranges of the low-frequency diagnostic signal and the high-frequency diagnostic signal to generate a corresponding fault pattern further comprises the following steps:
extracting the high-frequency diagnostic signal in the target state signal, and extracting, by the envelope analysis unit, an envelope feature of the high-frequency diagnostic signal through Hilbert transform and demodulation analysis to obtain modulation information and transient impact information to determine a first high-frequency fault pattern;
performing, by the frequency domain feature extraction unit, spectrum analysis on the high-frequency diagnostic signal, and extracting a high-frequency component and a harmonic wave to recognize a high-frequency vibration source to determine a second high-frequency fault pattern;
obtaining, by the time-frequency domain feature extraction unit, a pulse amplitude and a voltage phase of the high-frequency diagnostic signal on a set time scale to obtain a third high-frequency fault pattern; and
determining a target high-frequency fault pattern according to the first high-frequency fault pattern, the second high-frequency fault pattern, and the third high-frequency fault pattern.

20. The evaluation apparatus for an electromechanical state of a transformer according to claim 11, further comprising a decision module, responding to a fault pattern and displaying a fault through a visual tool, wherein
the decision module comprises a display unit and an alarm unit, and the display unit displays a target low-frequency fault pattern or/and a target high-frequency fault pattern through a vibration frequency domain diagram or/and a partial discharge PRPD diagram; and
the alarm unit sends a fault pattern of a target transformer to a remote platform or/and a mobile terminal.
